(19) United States
(12) Patent Application Publication
(10) Pub. No.: US 2012/0239268 A1
(43) Pub. Date: Sep. 20, 2012

(54) METHOD AND SYSTEM OF ENERGY SAVING CONTROL

(75) Inventors: Syuan-Yi Chen, Changhua County (TW); Yu-Hui Lin, Miaoli County (TW); Chih-Tang Chang, Miaoli County (TW)

(73) Assignee: INDUSTRIAL TECHNOLOGY RESEARCH INSTITUTE, Hsin-Chu (TW)

(21) Appl. No.: 13/350,306

(22) Filed: Jan. 13, 2012

(30) Foreign Application Priority Data
Mar. 18, 2011 (TW) 100109421

(51) Int. Cl. G05D 1/02; B60T 7/12; G08G 1/16

(52) U.S. Cl. 701/96

(57) ABSTRACT

The application relates to a method and system of energy saving control for a vehicle, the method includes the steps of detecting a total distance between a specific vehicle and another vehicle in front, referring as the preceding vehicle, the speed of the preceding vehicle and the dynamic information of the specific vehicle; obtaining a safe distance, an energy saving buffer zone and a cruise control activation zone according to the total distance between a preceding vehicle and the specific vehicle, the speed of the preceding vehicle and the dynamic information of the specific vehicle; and determining whether the preceding vehicle enters the energy saving buffer zone, and enable an energy saving control operation while activating the specific vehicle to enter into a following mode if the preceding vehicle stays in the cruise control activation zone.

### TECHNICAL FIELD

The present disclosure relates to a method and system of energy saving control, and more particularly, to a method and system of energy saving control adapted for vehicles, especially for electric vehicles or hybrid vehicles.

### TECHNICAL BACKGROUND

Generally, adaptive cruise control (ACC) system, being an important sub-system of modern intelligent vehicle safety system, is designed to use either a radar or laser setup to allow the vehicle to keep pace with the car it is following, slow when closing in on the vehicle in front and accelerating again to the preset speed when traffic allows. Moreover, some ACC systems also feature forward collision warning systems, which warns the driver if a vehicle in front—given the speed of both vehicles—gets too close within the preset headway or braking distance, thereby, resulting that the happening of accident due to human error is minimized as the perceptive and cognitive load acceptable to the driver is reduced, and thus, the safety and driving comfort are improved.

According to statistical records, the driving habit of stepping hard on brake or gas pedals not only is an unsafe driving behavior, but also can increase the oil consumption of the vehicle by more than 30%, and that is also true for electric vehicles. It is noted that when the acceleration pedal of an electric vehicle is being stepped hard and abruptly, not only such driving behavior will cause the electric vehicle to consume more power since the instant electricity consumption of the vehicle is increased, but also such driving behavior will have adverse affect upon the state-of-health (SOH) of the battery that is used as the power source of the electric vehicle. Conventionally, the ACC system is only designed to function for maintaining a vehicle to move at a preset constant speed while utilizing an anti-collision means for allowing the vehicle to keep a safe distance away from the vehicle in front. However, the anti-collision means of the conventional ACC system can only be activated as soon as the vehicle in front is moving within the range of the safe distance. However, at the instant of the activation, certain vibration to the vehicle will be caused that may further cause discomfort to the passengers of the vehicle. Moreover, while the vehicle is cruising in an urban area, following the frequent speed change of the vehicles in front, i.e. the vehicles in the urban area will have to accelerate or decelerate very frequently due to high traffic on roads, the happening of the ACC system being activated instantly will become more often.

### TECHNICAL SUMMARY

In an embodiment, the present disclosure provides a method of energy saving control adapted for a vehicle, comprising the steps of:
detecting a total distance between a specific vehicle and another vehicle in front that is referred as the preceding vehicle, the speed of the preceding vehicle and the dynamic information of the specific vehicle;
obtaining a safe distance and an energy saving buffer zone according to the total distance between the preceding vehicle and the specific vehicle, the speed of the preceding vehicle and the dynamic information of the specific vehicle; and
determining whether the preceding vehicle had entered the energy saving buffer zone, and thus enabling an energy saving control operation while activating the specific vehicle to enter into a following mode if the preceding vehicle is in the energy saving buffer zone.

In another embodiment, the present disclosure provides a system of energy saving control adapted for a vehicle, comprising:
a detection device, for detecting a total distance between a specific vehicle and another vehicle in front that is referred as the preceding vehicle, the speed of the preceding vehicle and the dynamic information of the specific vehicle; and
an energy saving control device, coupled to the detection device so as to be used for obtaining a safe distance and an energy saving buffer zone according to the total distance between the preceding vehicle and the specific vehicle, the speed of the preceding vehicle and the dynamic information of the specific vehicle, while determining whether the preceding vehicle had entered the energy saving buffer zone, and thus enabling an energy saving control operation to be activated for controlling the specific vehicle to enter into a following mode based upon the calculation of the energy saving control operation if the preceding vehicle is in the energy saving buffer zone.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram showing a system of energy saving control adapted for a vehicle according to an embodiment of the present disclosure.

FIG. 2 h is a schematic diagram depicting how an energy saving buffer zone m(t) and a cruise control activation zone n(t) are obtained in an embodiment of the present disclosure.

FIG. 3 is a flow chart depicting the steps of a method of energy saving control adapted for a vehicle according to an embodiment of the present disclosure.

FIG. 4 is a flow chart depicting the steps of a method of energy saving control adapted for a vehicle according to another embodiment of the present disclosure.

FIG. 5 is a flow chart depicting the steps of an energy saving control operation performed in the present disclosure.

FIG. 6 is a flow chart depicting the steps of a fuzzy control operation performed in the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

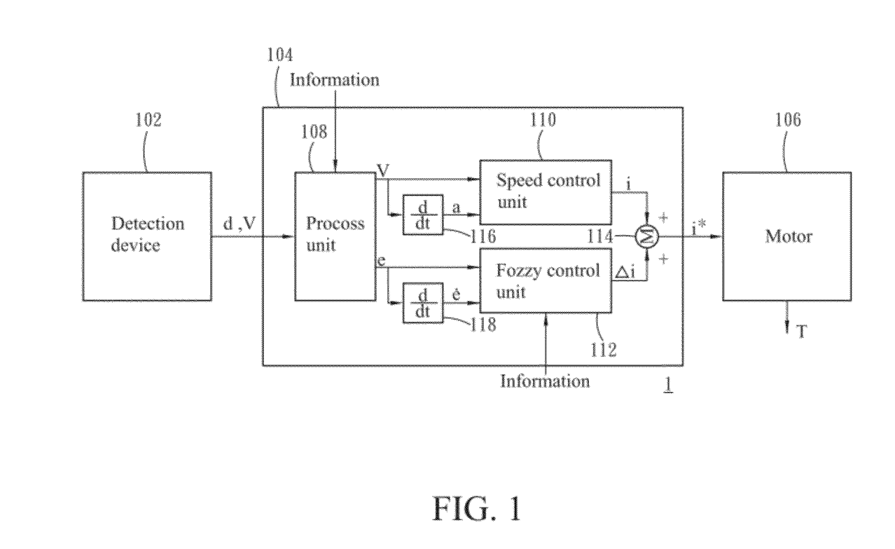

Please refer to FIG. 1, which is a schematic diagram showing a system of energy saving control adapted for a vehicle according to an embodiment of the present disclosure. As shown in FIG. 1, a system of energy saving control 1, that is being adapted for an electric vehicle or a hybrid vehicle, comprises: an detection device 102, an energy saving control device 104, and a motor 106. The detection device 102 is used for detecting a total distance between a specific vehicle and another vehicle in front that is referred as the preceding vehicle, the speed of the preceding vehicle and the dynamic information of the specific vehicle, in which the dynamic information of the specific vehicle includes a speed of the specific vehicle, a motor rotation speed of the specific vehicle and a state-of-charge (SOC) of a battery used in the specific vehicle and a depth-of-discharge (DOD) of the battery used in the specific vehicle, and the detection device 102 can be a radar device. Moreover, the detection device 102 can be adapted for detecting whether there is any vehicle moving within a specific range in front of the specific vehicle, and then enabling the specific vehicle to enter a constant speed mode so as to move at a constant speed if there is none. The energy saving control device 104, being coupled to the detection device 102, is used for obtaining a safe distance and an energy saving buffer zone according to the total distance between a preceding vehicle and the specific vehicle, the speed of the preceding vehicle and the dynamic information of the specific vehicle, while determining whether the preceding vehicle had entered the energy saving buffer zone, and thus enabling an energy saving control operation to be activated and used for controlling the specific vehicle to enter into a following mode based upon the calculation of the energy saving control operation if the preceding vehicle is in the energy saving buffer zone.

In addition, the energy saving control device 102 further has a process unit 108, which is provided for receiving the detection of the total distance between the specific vehicle and the preceding vehicle, the speed of the preceding vehicle and the dynamic information of the specific vehicle while basing upon the received total distance between the specific vehicle and the preceding vehicle, the speed of the preceding vehicle and the dynamic information of the specific vehicle to obtain the safe distance and the energy saving buffer zone. Moreover, the process unit 108 is further being designed to obtain a cruise control activation zone according to the speed of the preceding vehicle and the speed of the specific vehicle so as to be used as a base for making an evaluation to determine whether the preceding vehicle had entered the cruise control activation zone, and consequently the energy saving control operation is activated for controlling the specific vehicle to move following smoothly with the preceding vehicle based upon the calculation of the energy saving control operation if the preceding vehicle had entered the cruise control activation zone. However, if the preceding vehicle had moved out of the cruise control activation zone, the specific vehicle is released from the following mode. Substantially, the process unit 108 will control the specific vehicle to enter the following mode while maintaining the specific vehicle to keep a safe distance away from the preceding vehicle under the condition when the total distance between the preceding vehicle and the specific vehicle is not larger than a distance equal to the sum of the energy saving zone and the safe distance; and the process unit 108 will control the specific vehicle to enter a constant speed mode under the condition when the total distance between the preceding vehicle and the specific vehicle is larger than a distance equal to the sum of the energy saving zone and the safe distance. Under the following mode and under the condition when the preceding vehicle is accelerating/decelerating smoothly and steadily and the total distance between specific vehicle and the preceding vehicle is equal to or smaller than the distance equal to the sum of the cruise control activation zone and the safe distance, the process unit 108 will control the speed of the specific vehicle based upon the calculation of the energy saving control operation for enabling the specific vehicle to move following smoothly with the preceding vehicle while allowing the total distance between the specific vehicle and the preceding vehicle to be maintained not larger than a distance equal to the sum of the cruise control activation zone and the safe distance. On the other hand, also under the following mode but when the preceding vehicle is accelerating/decelerating in a violent manner and is moving out of the cruise control activation zone, i.e. the total distance between the specific vehicle and the preceding vehicle is larger than the sum of the cruise control activation zone and the safe distance, the process unit 108 will control the specific vehicle to abandon keeping the smooth following of the preceding vehicle and then enter a constant speed mode.

The energy saving control device 104 further comprises: a speed control unit 110, a fuzzy control unit 112 and an adder 114. The speed control unit 110 is coupled to the process unit 108 and used for obtaining a major current according to an acceleration and the speed of the preceding vehicle, whereas the acceleration is acquired using a differentiator 116. The fuzzy control unit 112 is coupled to the process unit 108 and used for performing a fuzzy control operation based upon a follow error and the differential of the follow error so as to obtain a complementary current, whereas the differential of the follow error is acquired using a differentiator 118. The adder 114 is provided for generating a total drive current by adding the values of the major current and the complementary current together so as to be used for driving a motor of the specific vehicle to generate a torque sufficient enough for maintaining the safe distance between the specific vehicle and the preceding vehicle. It is noted that the control of the energy saving control system 1 can be disengaged manually. That is, the energy saving control system 1 can release the specific vehicle from the following mode through the stepping on the brake of the specific vehicle that is performed by the driver.

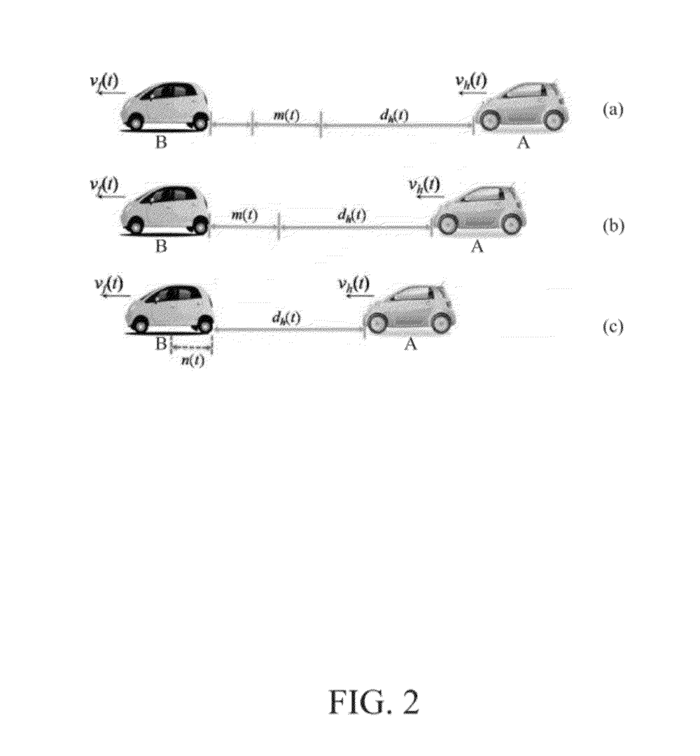

Please refer to FIG. 2, which is a schematic diagram depicting how an energy saving buffer zone m(t) and a cruise control activation zone n(t) are obtained in an embodiment of the present disclosure. As shown in FIG. 2, a safe distance dₕ(t) is determined according to the speed of the specific vehicle in a manner that the faster the specific vehicle is moving, the larger the safe distance will be, and vice versa. As vₕ(t) and v_{f}(t) are used for representing respectively the moving speeds of the vehicle A and the vehicle B, the energy saving buffer zone m(t), which is used as the base for controlling the activation of the energy saving operation and is defined considering the relative speed of the two vehicles A and B, is defined as the following formula:

$$m ( t ) = \frac{\vert {v}_{h} ( t ) - {v}_{f} ( t ) \vert}{v ( t )} \times {d}_{h} , v ( t ) = max ( {v}_{h} ( t ) , {v}_{ f} ( t ) ) \qquad ( 1 )$$

When the vehicle A is operated under the following mode, the evaluation for determining whether the preceding vehicle, i.e. the vehicle B, is operating in an energy saving manner is performed by determining whether the vehicle B is moving within the range of a cruise control activation zone n(t). If it is determined that the vehicle B is not operating in the energy saving manner, the system 1 will abandon the following mode and then activate a constant speed mode for enabling the specific vehicle, i.e. the e vehicle A, to move in the energy saving manner, according to which the cruise control activation zone n(t) is defined as the following formula:

$$n ( t ) = {( \frac{{v}_{h} ( t )}{{v}_{f} ( t )} )}^{2} \qquad ( 2 )$$

It is known that the dynamic model dynamic model for electric vehicles is complicated, whereas the dynamic characteristics of the electric vehicles can deeply be affected by external disturbances, such as running resistance, wind resistance, hill climbing resistance, and so on; and also the parameters relating to those external disturbances are generally governed by nonlinear time varying functions that are hard to acquired. Therefore, a good cruise control effect can be very difficult to achieve if only considering the acceleration and speed of the preceding vehicle. Thus, the present disclosure adopt the following formula as its dynamic model dynamic model for electric vehicles:

$${K}_{f} {i}^{*} = ( J + m \frac{{r}^{2}}{{G}^{2}} ) \frac{d {ω}_{r}}{d t} + B {ω}_{r} + {T}_{L} \qquad ( 3 )$$

wherein,
K_{f} represents a moment coefficient;
J represents a rotational inertia;
r represents a radius of a tire;
m represents a mass;
G represents a gear ratio;
ωᵣ represents a motor rotation speed;
i* represents a total drive current; and
T_{L} represents the lumped uncertainty.
   Moreover, T_{L} is defined by the following formula:

$${T}_{L} = \frac{r}{G} ( {μ}_{rr} m g + \frac{1}{2} ρ A {C}_{d} {v}^{2} + m g sin φ ) \qquad ( 4 )$$

wherein
μᵣᵣ represents a pavement friction coefficient;
g represents the acceleration of gravity;
ρ represents the air density
A represents the frontal area of a vehicle;
Cₐ represents a wind resistance coefficient;
v represents a vehicle speed; and
φ represents a gradient.

In the present disclosure, since all the external disturbances are lumped to be considered at once, the complexity of the dynamic model dynamic model for electric vehicles can be simplified, as T_{L} is designed to represent the lumped uncertainty affecting the cruise control performance of the electric vehicle. In addition, according to the simplified electric vehicle dynamic model, the total drive current i* is calculated using the following formula:

i*=i+Δi
wherein i represent a major current; and
   Δi represents a complementary current.

Thereafter, the total drive current i* is fed to the motor for driving the motor to generate a torque T in which the speed control unit 110 is adopted to calculate a major current for generating a basic driving force thus the specific vehicle A can follow the preceding vehicle B, and the fuzzy control unit 112, is adopted to calculate a complementary current for battling against the external disturbances including wind resistance, hill-climbing resistance and friction, as shown in FIG. 1. As shown in FIG. 2, as soon as the preceding vehicle B is within the range of the energy saving buffer zone, the system of the energy saving control that is mounted on the specific vehicle A for allowing the total distance d (t) between the specific vehicle A and the preceding vehicle B to be maintained no smaller than the safe distance dₕ(t). Nevertheless, since the moving of the specific vehicle A is prone to be affected by external disturbances, it is difficult to maintain the total distance d (t) exactly equal to the safe distance dₕ(t), whereas the magnitude of those external disturbances can be canceled using a estimation based upon a follow error e and the differential of the follow error \check{e}, without having to install different sensors on the specific vehicle A for detecting different external disturbances, such as the friction, wind resistance, etc., in respective.

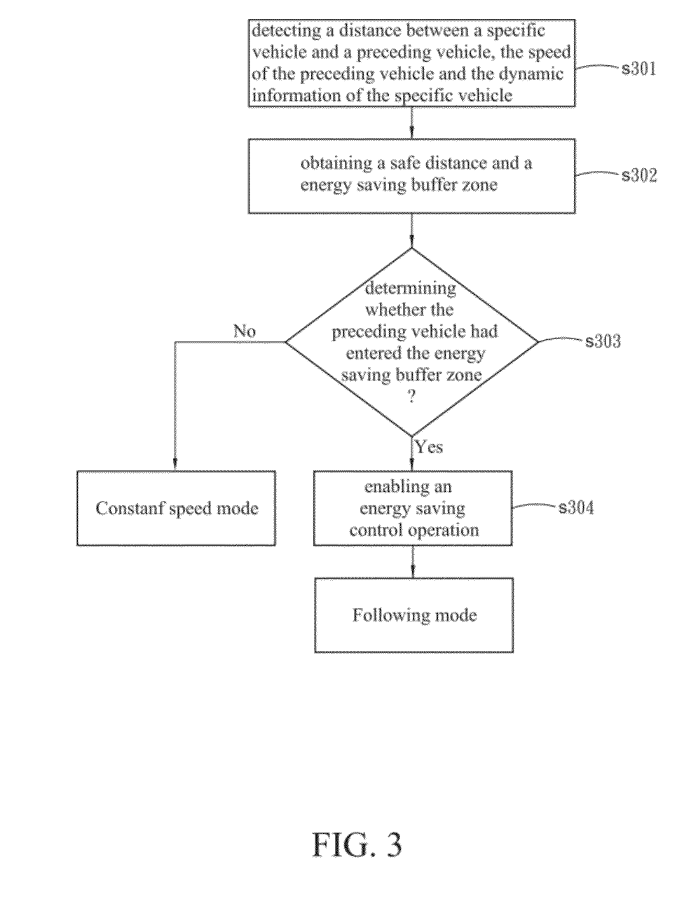

Please refer to FIG. 3, which is a flow chart depicting the steps of a method of energy saving control adapted for a vehicle according to an embodiment of the present disclosure, whereas the vehicle can be an electric vehicle or a hybrid vehicle. Before the start of the aforesaid energy saving control method which is performed using the energy saving control system 1 that is mounted on the specific vehicle A, as shown in FIG. 1 and FIG. 2, the energy saving control system 1 will activate its detection device 102 to detect whether there is any other vehicle in front within a specific range, and if there is none, the energy saving control system 1 will control the specific vehicle A to operate under a cruise mode and thus move at a constant speed, as that is shown in FIG. 2(a). However, if there is a vehicle in front, i.e. the preceding vehicle B is detected, the energy saving control method of FIG. 3 starts at the step s301 for enabling the detection device 102 to detect the total distance d(t) between a specific vehicle A and the preceding vehicle B, the speed of the preceding vehicle B and the dynamic information of the specific vehicle A, as the step s301 shown in FIG. 3, and then the flow proceeds to step s302. It is noted that the dynamic information of the specific vehicle includes a speed of the specific vehicle, a motor rotation speed of the specific vehicle A and a SOC of a battery used in the specific vehicle A and a DOD of the battery used in the specific vehicle A. At step s302, the energy saving control device 104 will perform a calculation based upon the total distance d (t) between the preceding vehicle B and the specific vehicle A, the speed of the preceding vehicle B and the dynamic information of the specific vehicle A for obtaining a safe distance dₕ(t) and an energy saving buffer zone m(t); and then the flow proceeds to step s303. At step s303, the energy saving control device 104 is activated to determine whether the preceding vehicle B had entered the energy saving buffer zone m(t), and if so, the flow will proceeds to step s304 for enabling an energy saving control operation while activating the specific vehicle A to enter into a following mode, as shown in FIG. 2(b); otherwise, the specific vehicle A is enabled to enter the constant speed mode. Moreover, in the present embodiment when the total distance d(t) between the preceding vehicle B and the specific vehicle A is smaller than or equal to a distance equal to the sum of the energy saving zone m(t) and the safe distance dₕ(t), the process unit 108 of the energy saving control device 104 will enable the specific vehicle A to enter the following mode. On the other hand, when the total distance d (t) between the preceding vehicle B and the specific vehicle A is larger than the distance equal to the sum of the energy saving zone m(t) and the safe distance dₕ(t), the process unit 108 of the energy saving control device 104 will enable the specific vehicle A to enter the constant speed mode.

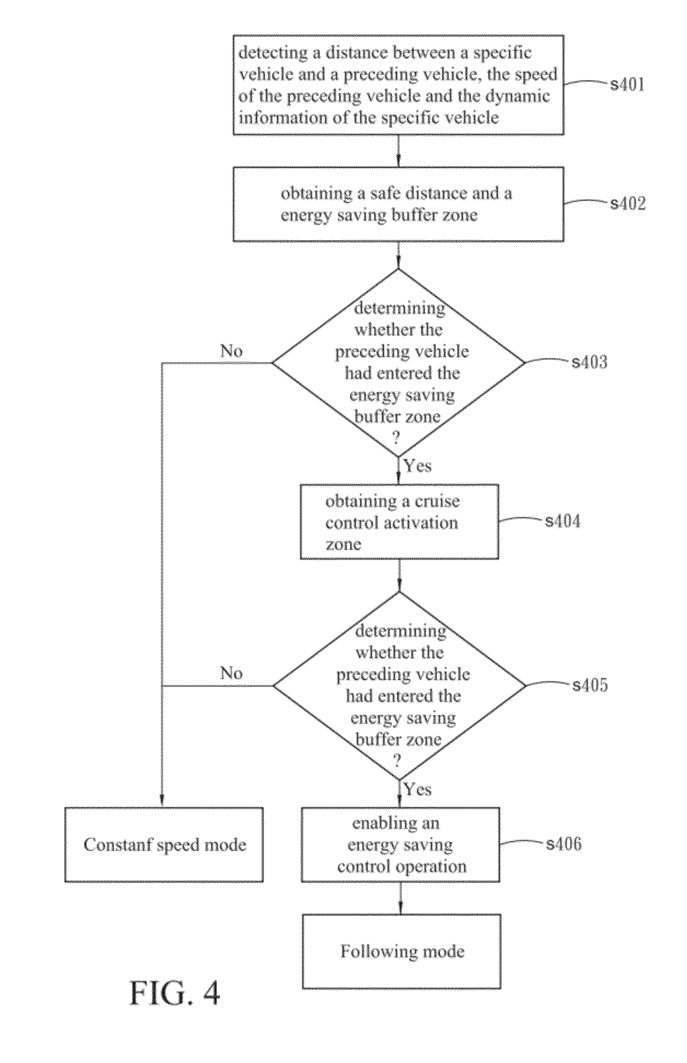

Please refer to FIG. 4, which is a flow chart depicting the steps of a method of energy saving control adapted for a vehicle according to another embodiment of the present disclosure, whereas the vehicle can be an electric vehicle or a hybrid vehicle, and also the method is performed using the energy saving control system 1 that is mounted on the specific vehicle A as shown in FIG. 1 and FIG. 2. The difference between the present embodiment of FIG. 4 and the foregoing embodiment of FIG. 3 is that: there is further a cruise control activation zone n(t) defined in the present embodiment. Similarly, before the start of the aforesaid energy saving control method, the energy saving control system 1 will activate its detection device 102 to detect whether there is any other vehicle in front with a specific range, and if there is none, the energy saving control system 1 will control the specific vehicle A to operate under a cruise mode and thus move at a constant speed. However, if there is a vehicle in front, i.e. the preceding vehicle B is detected, the energy saving control method of FIG. 4 starts at the step s401 for enabling the detection device 102 to detect the total distance d(t) between a specific vehicle A and the preceding vehicle B, the speed of the preceding vehicle B and the dynamic information of the specific vehicle A, as the step s301 shown in FIG. 3, and then the flow proceeds to step s402. At step s402, the energy saving control device 104 will perform a calculation based upon the total distance d (t) between the preceding vehicle B and the specific vehicle A, the speed of the preceding vehicle B and the dynamic information of the specific vehicle A for obtaining a safe distance dₕ(t) and an energy saving buffer zone m(t), to be used as an adaptive cruise control for switching between accelerating, decelerating, entering the following mode, or entering the constant speed mode; and then the flow proceeds to step s403. At step s403, the energy saving control device 104 is activated to determine whether the preceding vehicle B had entered the energy saving buffer zone m(t), and if so, the specific vehicle A will be controlled to move following the preceding vehicle B while maintaining the two vehicles A and B to be spaced by the safe distance dₕ(t) away while enabling the flow to proceed to step s404 for obtaining a cruise control activation zone n(t) and then proceeding to the step s405; otherwise, the specific vehicle A is enabled to enter the constant speed mode. At step s405, an evaluation is made for determining whether the preceding vehicle B had entered the cruise control activation zone n(t); and if the preceding vehicle had entered the cruise control activation zone, the flow will proceeds to step s406 for activating the calculation of the energy saving control operation so as to control the specific vehicle A to maintain at the following mode and thus move following smoothly with the preceding vehicle B, as shown in FIG. 2(c); otherwise when the preceding vehicle B had moved out of the cruise control activation zone n(t), the specific vehicle A is enabled to enter the constant speed mode. Moreover, in the present embodiment when the preceding vehicle B is accelerating/decelerating smoothly and steadily and the total distance d (t) between the specific vehicle A and the preceding vehicle B is not larger than the distance equal to the sum of the cruise control activation zone n(t) and the safe distance dₕ(t), the process unit 108 of the energy saving control device will control the specific vehicle A to move at a speed based upon the energy saving control operation for enabling the specific vehicle A to move following smoothly with the preceding vehicle B while allowing the total distance d (t) between the specific vehicle A and the preceding vehicle B to be maintained not larger than a distance equal to the sum of the safe distance dₕ(t) and the cruise control activation zone n(t). Moreover, when the preceding vehicle B is accelerating or decelerating in a violent manner and is moving out of the cruise control activation zone n(t), the process unit 108 will control the specific vehicle A to abandon keeping the smooth following of the preceding vehicle B and then enter a constant speed mode.

In addition, in the present embodiment, after the specific vehicle A had moved following the preceding vehicle B for a period of time, and detects that the preceding vehicle B is moving at a speed slower than the specific vehicle A, i.e. vₕ(t)>v_{f}(t), the energy saving control system on the specific vehicle A will keep detecting and monitoring the speed of the preceding vehicle B while updating the energy saving buffer zone m(t) and the safe distance dₕ(t), and when the total distance d (t) between the specific vehicle A and the preceding vehicle B is smaller than or equal to the sum of the safe distance dₕ(t) and the energy saving buffer zone m(t), the energy saving control system will activate an energy saving control upon the specific vehicle A. Consequently, the energy saving control will keep updating the energy saving buffer zone m(t) according to the variation of the relative speed between the two vehicles A and B, while adjusting the speed of the specific vehicle A in response to the speed change of the preceding vehicle B for enabling the specific vehicle A to following the moving of the preceding vehicle B smoothly without any sudden acceleration or deceleration, and simultaneously enabling the total distance between the two vehicles A and B to approach the safe distance dₕ(t) smoothly. However, if the preceding vehicle B is moving out of the cruise control activation zone n(t), the energy saving control system will determine that the speed variation of the preceding vehicle B is not energy efficient and thus will control the specific vehicle A to abandon the following mode for following of the preceding vehicle B and then enter a constant speed mode.

Furthermore, in addition to the total distance d(t) between a specific vehicle A and the preceding vehicle B, the speed of the preceding vehicle B and the dynamic information of the specific vehicle A, the energy saving control system1 of the present disclosure can further use other factors, including the motor performance of the specific vehicle A, the characteristics of the battery used in the specific vehicle A, the dynamic cruising characteristics, such as tire friction, slope gradient, wind resistance, for obtaining the energy saving buffer zone m(t), the cruise control activation zone n(t), the safe distance dₕ(t) and the energy saving control operation, so as to be used in the adaptive energy saving control for switching between accelerating, decelerating, entering the following mode, or entering the constant speed mode. Consequently, the energy saving control system of the present disclosure should comprise: the speed control unit 110, for calculating the driving force that is sufficient enough for keeping up with the moving speed of the preceding vehicle B; and the fuzzy control unit 112 with fuzzy logic, capable of simultaneously taking the factors including the cruising environment, the motor condition and battery condition into consideration for calculating a force sufficient enough for overcoming the external disturbances including the wind resistance, hill climbing force and friction.

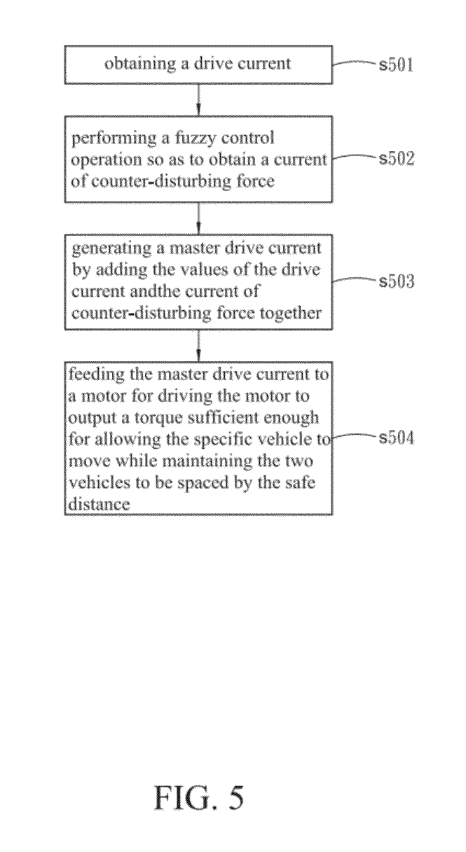

Please refer to FIG. 5, which is a flow chart depicting the steps of an energy saving control operation performed in the present disclosure. In this embodiment, the energy saving control operation comprises the following steps:
s501: obtaining a major current i according to the acceleration and speed of the preceding vehicle B;
s502: performing a fuzzy control operation based upon a follow error e and the differential of the follow error \check{e}, so as to obtain a complementary current Δi;
s503: generating a total drive current i* by adding the values of the major current i and the complementary current Δi; and
s504: feeding the total drive current i* to a motor of the specific vehicle A for the generation of a suitable torque T to maintain the safe distance between the specific vehicle A and the preceding vehicle B.

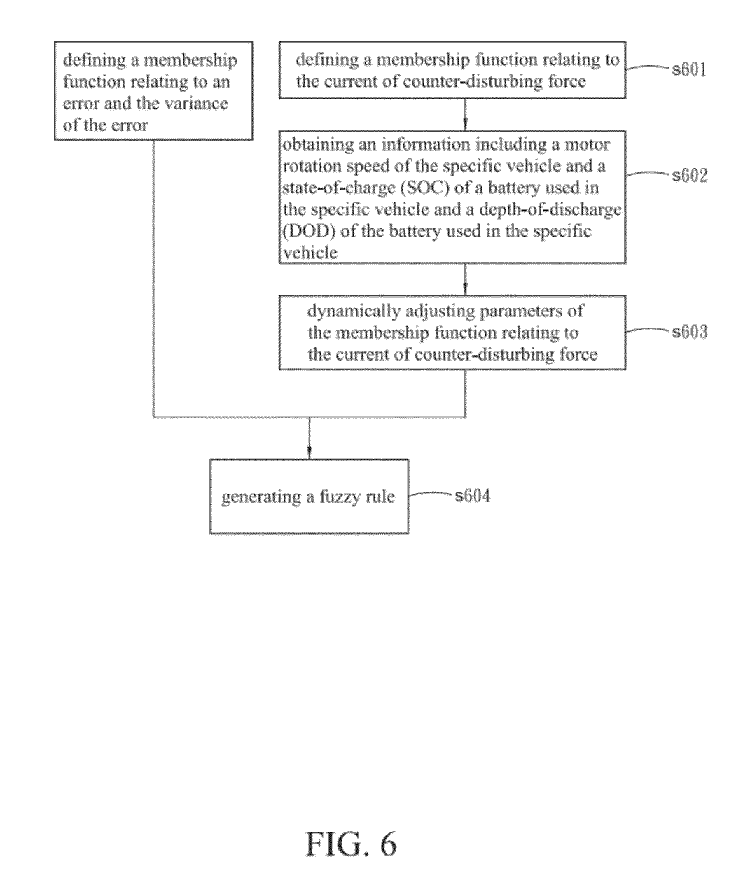

Please refer to FIG. 6, which is a flow chart depicting the steps of a fuzzy control operation performed in the present disclosure. In this embodiment, the fuzzy control operation comprises the following steps:
s601: defining a membership function for the follow error e and the differential of the follow error \check{e} so as to generate a membership function for the complementary current Δi
s602: obtaining an information including a motor rotation speed of the specific vehicle A and a SOC of a battery used in the specific vehicle A and a DOD of the battery used in the specific vehicle A;
S603: dynamically adjusting parameters of the membership function for the complementary current Δi based upon the information including a motor rotation speed of the specific vehicle A and a SOC of a battery used in the specific vehicle A and a DOD of the battery used in the specific vehicle A, such as the following table 1 for adjusting the membership function based upon a motor rotation speed of the specific vehicle A and a SOC of a battery used in the specific vehicle A and a DOD of the battery used in the specific vehicle A;

TABLE 1

| | | |
|---|---|---|
| Motor rotation | | |
| speed | Battery SOC | Battery DOD |

| | | | | | | |
|---|---|---|---|---|---|---|
| status | low | high | low | high | low | high |
| current | large | small | large | small | small | large |

s604: generating fuzzy rules and consequently generating a fuzzy rule database

For instance, in the step of s604, the present disclosure uses the If-Then fuzzy algorithm to assemble all the input fuzzy sets into all possible statuses while mapping the same to their corresponding parameters that are being outputted. Thereby, under the condition that there is no exact vehicle model, the system and method of the present disclosure is able to use the follow error, i.e. e(t)=dₕ(t)−d(t) and the differential of the follow error \check{e}(t) to estimate and obtain the complementary current Δi, and thus to enable the total distance d(t) between the specific vehicle A and the preceding vehicle B to be maintained to equal exactly to the safe distance dₕ(t) as the membership function of the complementary current Δi can be defined based upon the membership function relating to the follow error e and the differential of the follow error \check{e}. As shown in the following table 2, there are seven types of membership functions designed for the follow error e(t) and the differential of the follow error \check{e}(t), and there are forty nine fuzzy rules in the fuzzy rule database to be used for defining and generating the membership function relating to the complementary current Δi. In the table 2, N represents negative, P represents positive, S represent small, M represents middle, and B represents big, and the parameters in the membership function relating to the complementary current Δi will be dynamically adjusted according to factors including actual motor rotation speed, battery SOC and battery DOD, and so on. Moreover, the parameters in the membership function relating to the complementary current Δi that are shown in table 2 can be varied and adjusted dynamically according to actual design, measurement and requirement.

TABLE 2

| | ė | | | | | | |
|---|---|---|---|---|---|---|---|
| | NB | NM | NS | ZO | PS | PM | PB |
| e | Δi | | | | | | |
| PB | ZO | PS | PM | PB | PB | PB | PB |
| PM | NS | ZO | PS | PM | PB | PB | PB |
| PS | NM | NS | ZO | PS | PM | PB | PB |
| ZO | NB | NM | NS | ZO | PS | PM | PB |
| NS | NB | NB | NM | NS | ZO | PS | PM |
| NM | NB | NB | NB | NM | NS | ZO | PS |
| NB | NB | NB | NB | NB | NM | NS | ZO |

To sum up, the present disclosure provide a system and method of energy saving control, which is used for enabling a specific vehicle to cruise smoothly and energy efficiently in a following mode while driving tailing another vehicle, and also is capable of improving the driving comfort and battery efficiency without causing any safety concern. In addition, although the moving of the specific vehicle A can easily affected by external disturbances such as friction and wind resistance, such external disturbances can be overcome since the magnitude of those external disturbances can be calculated using a calculation based upon a follow error e and the differential of the follow error \check{e}, so that it is no need to have many sensors mounted on the specific vehicle A for detecting different external disturbances, such as the friction, wind resistance, etc., in respective, resulting that not only the efficiency of the energy saving control effect is improved and the manufacturing cost is reduced, but also the problems such as the requiring for hard braking due to the abrupt deceleration of the preceding vehicle, the blindly speeding up due to the abrupt acceleration from the preceding vehicle can be avoided.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A method of energy saving control adapted for a vehicle, comprising the steps of:
detecting a total distance between a specific vehicle and another vehicle in front that is referred as the preceding vehicle, the speed of the preceding vehicle and the dynamic information of the specific vehicle;
obtaining a safe distance and an energy saving buffer zone according to the total distance between the preceding vehicle and the specific vehicle, the speed of the preceding vehicle and the dynamic information of the specific vehicle; and
determining whether the preceding vehicle had entered the energy saving buffer zone, and thus enabling an energy saving control operation while activating the specific vehicle to enter into a following mode if the preceding vehicle is in the energy saving buffer zone.

2. The method of claim 1, wherein the specific vehicle is a vehicle selected from the group consisting of an electric vehicle and a hybrid vehicle.

3. The method of claim 1, wherein the dynamic information of the specific vehicle includes a speed of the specific vehicle, a motor rotation speed of the specific vehicle, a state-of-charge (SOC) of a battery used in the specific vehicle and a depth-of-discharge (DOD) of the battery used in the specific vehicle.

4. The method of claim 1, further comprising the step of:
detecting whether there is any vehicle moving in front of the specific vehicle, and then enabling the specific vehicle to enter a constant speed mode if there is none.

5. The method of claim 1, further comprising the step of:
obtaining a cruise control activation zone according to the speed of the preceding vehicle and the speed of the specific vehicle.

6. The method of claim 5, further comprising the step of:
determining whether the preceding vehicle had stayed in the cruise control activation zone, and then enabling the specific vehicle to move following smoothly with the preceding vehicle based upon the calculation of the energy saving control operation if the preceding vehicle had entered the cruise control activation zone.

7. The method of claim 1, further comprising the step of:
enabling the specific vehicle to enter the following mode under the condition when the total distance between the preceding vehicle and the specific vehicle is not larger than a distance equal to the sum of the energy saving zone and the safe distance.

8. The method of claim 1, further comprising the step of:
enabling the specific vehicle to enter a constant speed mode under the condition when the total distance between the preceding vehicle and the specific vehicle is larger than a distance equal to the sum of the energy saving zone and the safe distance.

9. The method of claim 5, further comprising the step of:
controlling the speed of the specific vehicle based upon the energy saving control operation for enabling the specific vehicle to move following smoothly with the preceding vehicle while allowing the total distance between the specific vehicle and the preceding vehicle to be maintained not larger than a distance equal to the sum of the cruise control activation zone and the safe distance, under the condition when the preceding vehicle is accelerating/decelerating smoothly and steadily and the total distance between the specific vehicle and the preceding vehicle is not larger than the distance equal to the sum of the cruise control activation zone and the safe distance.

10. The method of claim 5, further comprising the step of:
enabling the specific vehicle to abandon keeping the smooth following of the preceding vehicle and then enter a constant speed mode under the condition when the preceding vehicle is accelerating/decelerating in a violent manner and is moving out of the cruise control activation zone.

11. The method of claim 6, wherein the specific vehicle can be controlled manually or automatically to abandon keeping the smooth following of the preceding vehicle.

12. The method of claim 7, wherein the specific vehicle is controlled to abandon the following mode through the stepping on the brake of the specific vehicle that is performed by the driver.

13. The method of claim 1, wherein the specific vehicle can be controlled manually or automatically to enter an energy saving control mode.

14. The method of claim 1, wherein the energy saving control operation further comprises the steps of:
obtaining a major current according to an acceleration and the speed of the preceding vehicle;
performing a fuzzy control operation based upon a follow error and the differential of the follow error so as to obtain a complementary current;
generating a total drive current by adding the values of the major current and the complementary current; and
feeding the total drive current to a motor of the specific vehicle for the generation of a suitable torque to maintain the safe distance between the specific vehicle and the preceding vehicle.

15. The method of claim 14, wherein the fuzzy control operation further comprises the steps of:
generating a membership function for the complementary current based upon the follow error and the differential of the follow error;
obtaining an information including a motor rotation speed of the specific vehicle and a SOC of a battery used in the specific vehicle and a DOD of the battery used in the specific vehicle;
dynamically adjusting parameters of the membership function relating to the complementary current according to the information including the motor rotation speed of the specific vehicle and the SOC of the battery used in the specific vehicle and the DOD of the battery used in the specific vehicle; and
generating fuzzy rules.

16. A system of energy saving control adapted for a vehicle, comprising:
a detection device, for detecting a total distance between a specific vehicle and another vehicle in front that is referred as the preceding vehicle, the speed of the preceding vehicle and the dynamic information of the specific vehicle; and
an energy saving control device, coupled to the detection device so as to be used for obtaining a safe distance and an energy saving buffer zone according to the total distance between the preceding vehicle and the specific vehicle, the speed of the preceding vehicle and the dynamic information of the specific vehicle, while determining whether the preceding vehicle had entered the energy saving buffer zone, and thus enabling an energy saving control operation to be activated and used for controlling the specific vehicle to enter into a following mode based upon the calculation of the energy saving control operation if the preceding vehicle is in the energy saving buffer zone.

17. The system of claim 16, wherein the specific vehicle is a vehicle selected from the group consisting of an electric vehicle and a hybrid vehicle.

18. The system of claim 16, wherein the detection device is substantially a radar device.

19. The system of claim 16, wherein the dynamic information of the specific vehicle includes a speed of the specific vehicle, a motor rotation speed of the specific vehicle, a SOC of a battery used in the specific vehicle and a DOD of the battery used in the specific vehicle.

20. The system of claim 16, wherein the detection device is further being designed to detect whether there is any vehicle moving in front of the specific vehicle, and if there is no vehicle in front, the specific vehicle is enabled to enter a constant speed mode.

21. The system of claim 16, wherein the energy saving control device further comprises:
a process unit, for receiving the detection of the total distance between the specific vehicle and the preceding vehicle, the speed of the preceding vehicle and the dynamic information of the specific vehicle while basing upon the received total distance between the specific vehicle and the preceding vehicle, the speed of the preceding vehicle and the dynamic information of the specific vehicle to obtain the safe distance and the energy saving buffer zone.

22. The system of claim 21, wherein the process unit further is designed to obtain a cruise control activation zone according to the speed of the preceding vehicle and the speed of the specific vehicle so as to be used as a base for making an evaluation to determine whether the preceding vehicle had entered the cruise control activation zone, and consequently the energy saving control operation is activated for controlling the specific vehicle to move following smoothly with the preceding vehicle based upon the calculation of the energy saving control operation if the preceding vehicle stayed in the cruise control activation zone.

23. The system of claim 21, wherein the specific vehicle is enabled to enter the following mode under the condition when the total distance between the preceding vehicle and the specific vehicle is not larger than a distance equal to the sum of the energy saving zone and the safe distance.

24. The system of claim 21, wherein the specific vehicle is enabled to enter a constant speed mode under the condition when the total distance between the preceding vehicle and the specific vehicle is larger than a distance equal to the sum of the energy saving zone and the safe distance.

25. The system of claim 21, wherein the speed of the specific vehicle is controlled based upon the energy saving control operation for enabling the specific vehicle to move following smoothly with the preceding vehicle while allowing the total distance between the specific vehicle and the preceding vehicle to be maintained not larger than a distance equal to the sum of the cruise control activation zone and the safe distance, under the condition when the preceding vehicle is accelerating/decelerating smoothly and steadily and the total distance between specific vehicle and the preceding vehicle is not larger than the distance equal to the sum of the cruise control activation zone and the safe distance.

26. The system of claim 21, wherein the specific vehicle is enabled to abandon keeping the smooth following of the preceding vehicle and then enter a constant speed mode under the condition when the preceding vehicle is accelerating/decelerating in a violent manner and is moving out of the cruise control activation zone.

27. The system of claim 21, wherein the energy saving control device further comprises:
a speed control unit, coupled to the process unit, for obtaining a major current according to an acceleration and the speed of the preceding vehicle;
a fuzzy control unit, coupled to the process unit, for performing a fuzzy control operation based upon a follow error and the differential of the follow error so as to obtain a complementary current; and
an adder, for generating a total drive current by adding the values of the major current and the complementary current so as to be used for driving a motor of the specific vehicle to generate a torque sufficient enough for maintaining the safe distance between the specific vehicle and the preceding vehicle.

28. The system of claim 27, wherein the fuzzy control unit is further designed to performed the following steps:
generating a membership function for the complementary current based upon the follow error and the differential of the follow error;
obtaining an information including a motor rotation speed of the specific vehicle and a SOC of a battery used in the specific vehicle and a DOD of the battery used in the specific vehicle;
dynamically adjusting parameters of the membership function relating to the complementary current according to the information including the motor rotation speed of the specific vehicle, the SOC of the battery used in the specific vehicle and the DOD of the battery used in the specific vehicle; and
generating fuzzy rules.
